(19) United States
(12) Patent Application Publication
(10) Pub. No.: US 2018/0323019 A1
(43) Pub. Date: Nov. 8, 2018

(54) KEYBOARD SWITCH

(71) Applicant: DONGGUAN CITY KAIHUA ELECTRONICS CO., LTD, Dongguan (CN)

(72) Inventor: Fuxi Wu, Dongguan (CN)

(21) Appl. No.: 16/033,648

(22) Filed: Jul. 12, 2018

Related U.S. Application Data
(63) Continuation of application No. PCT/CN2017/070647, filed on Jan. 9, 2017.

(30) Foreign Application Priority Data
Jan. 13, 2016 (CN) 201620025219.1

(51) Int. Cl. H01H 3/12; H01H 13/705; H01H 13/52; H01H 13/20

(52) U.S. Cl. CPC H01H 3/125; H01H 13/705; H01H 13/52; H01H 2013/525; H01H 2227/036; H01H 2233/07; H01H 13/20

(57) ABSTRACT

A balance mechanism (180) and a keyboard switch (100) including the balance mechanism (180) are provided. The balance mechanism (180) comprises a first frame (181) and a second frame (182) rotatable relative to each other, which are both of hollow structures with matched shapes and sizes. When the first frame (181) and the second frame (182) are in a superimposed state, a dynamic contact (130) and a static contact (120) are electrically connected. A relative rotation between the first frame (181) and the second frame (182) drives the moving contact (130) to move, achieving separation and contact between the dynamic contact (130) and the static contact (120), thereby turning on and off the switch. The keyboard switch (100) is thin, thus achieving miniaturization of the switch; the switch prevents a guide core (160) from tilting and being stuck in the button, which is convenient for operation.

### CROSS-REFERENCE TO RELATED APPLICATION

This is a continuation of International Application No. PCT/CN2017/070647, filed on Jan. 9, 2017, which claims the priority benefits of China Application No. 201620025219.1, filed on Jan. 13, 2016. The entirety of each of the above-mentioned patent applications is hereby incorporated by reference herein and made a part of this specification.

### FIELD OF THE INVENTION

The present application relates to the felid of keyboard switches, especially to a balance mechanism and a keyboard switch including the balance mechanism.

### BACKGROUND OF THE INVENTION

A keyboard switch, as the name suggests, is a switch applied to and installed on a keyboard, which keyboard switch mainly includes a base body, an upper cover, a static contact, a dynamic contact and a guide core; the upper cover and the base body are arranged such that a holding cavity is formed; the static contact, the dynamic contact and the guide core are arranged in the holding cavity, one end of the guide core protruding beyond the holding cavity. The guide core moves upwards and downwards upon pressed, such that force acts on the dynamic contact through the guide core to connect or disconnect the dynamic contact with (from) the static contact, turning on and off the keyboard.

Although keyboard switches of this structure may connect or disconnect the dynamic contact with (from) the static contact, the keyboard switches still have the following disadvantages. On one hand, the guide core is normally a guide rod, which is thick; on the other hand, since the guide core is mounted in the center of the bottom of a keycap, when a finger works on an edge of one side of the keycap, the guide core cannot be pressed down firmly; therefore, the guide core may tilt and be stuck, and thus the static contact and the dynamic contact cannot be connected, which is inconvenient.

### SUMMARY OF THE INVENTION

In order to deal with the above issue, the present application provides a balance mechanism which is thin with convenient operation, and capable of miniaturizing the switch and avoiding the guide core from tilting or being stuck, and a keyboard switch including the balance mechanism.

Technical solutions provided by the present application includes: a balance mechanism includes a first frame and a second frame which are rotatable relative to each other; the first frame and the second frame are both of hollow structures with matched shapes and sizes; while the first frame and the second frame are superimposed, the dynamic contact and the static contact are electrically connected; while the dynamic contact and the static contact as a whole are of an “X” structure, the dynamic contact and the static contact are detached. Further to the implementation above, both the first frame and the second frame are quadrangular; the first frame includes a first side, a second side, a third side and a fourth side connected sequentially, the first side being parallel to the third side, the second side being parallel to the fourth side; the second frame includes a fifth side, a sixth side, a seventh side and an eighth side connected sequentially, the fifth side being parallel to the seventh side, the sixth side being parallel to the eighth side; first convex columns are respectively arranged in the middle of the first side and the third side symmetrically; first holes are respectively arranged in the middle of the fifth side and the seventh symmetrically; first inclined planes are respectively arranged in the middle of the first side and the third side symmetrically; second inclined planes are respectively arranged along the fifth side and the seventh side; the first inclined planes and the second inclined planes are superimposed with each other and the first convex columns are rotatably mounted in the first holes, such that the first frame and the second frame may rotate along the first inclined planes and the second inclined planes centered on the first holes; second convex columns are respectively arranged at one end of each of the first side and a third side symmetrically; third convex columns are respectively arranged at one end of each of the fifth side and the seventh side symmetrically away from the second convex columns.

A keyboard switch includes the balance mechanism described above includes a base body, a static contact, a dynamic contact, a cover, a keycap, a guide core configured for moving the dynamic contact so as to contact the static contact with the dynamic contact, and a return spring applying force on the guide core which returns under the force; the cover is buckled on the base body; the static contact and the dynamic contact are both arranged on the base body; one end of the guide core is installed on and capable of moving upwards and downwards relative to the base body; the other end of the guide core passes through the cover and is under the keycap; both upper and lower ends of the return spring are respectively abutted against the guide core and the base body; the keyboard switch further includes a balance mechanism positioned between the cover and the base body and configured for guiding the keycap to balanced downward push so as to avoid the guide core from tilting.

Further to the implementation above, each of two opposite sides of the bottom of the cover provides two support tables; the second convex columns and the third convex columns are slidably installed on the support tables.

Further to the implementation above, the two support tables are spaced away from each other with a notch formed therebetween; the guide core provides a positioning component corresponding to the notch, which positioning component is stuck in the notch.

Further to the implementation above, the base body provides support bases where four corners of the balance mechanism are corresponded; the first frame and the second frame may be stuck in the support bases.

Further to the implementation above, a side of the guide core facing the base body provides a guide column; correspondingly, the base body provides a guide hole; the guide column may be mounted in the guide hole and capable of moving upwards and downwards along the guide hole.

Further to the implementation above, the static contact includes a static contact point and a first welding leg; the dynamic contact includes a dynamic contact point and a second welding leg; the static contact point and the dynamic contact point are arranged opposite to each other; both the first welding leg and the second welding leg protrude beyond the base body.

Advantages of the present application include:

1. The first frame and the second frame of the balance mechanism rotate relative to each other so as to move the dynamic contact, thus detaching or connecting the dynamic contact from or with the static contact and turning on or off the switch. On one hand, the balance mechanism works on the dynamic contact such that the guide core need not be too long, and each of the components is connected in a compact and simple way; furthermore, while the switch is in the on-state, the first frame and the second frame are superimposed, such that the keyboard switch of the present application is thin and small in size, which helps miniaturize the switch; on the other hand, the cover is arranged between the guide core and the keycap, such that interior part of the balance mechanism is capable of supporting two ends of the cover while the keycap is under pressure, such that two sides of the guide core are under equal forces and the guide core is not liable to tilting or being stuck, which achieves comfortable hand feeling with convenient operation.

2. The first frame and the second frame are rotatably mounted in the first hole via the first convex column, such that the first frame and the second frame may rotate along the first inclined planes and the second inclined planes centered on the first holes so as to move the dynamic contact. Furthermore, the first frame and the second frame are slidably installed on the support tables of the cover via the second convex columns and the third convex columns, which makes the structure of the keyboard switch compact with high space utilization and thinness, thus facilitating product miniaturization.

3. A notch is provided between the two support tables; the guide core provides a positioning component to which the notch is corresponded, which positioning component is stuck in the notch, thus further avoiding the guide core from tilting or being stuck while moving upwards and downwards and ensuring smooth operation.

4. The guide core provides a guide column; correspondingly, the base body provides a guide hole. The guide column may be mounted in the guide hole and capable of moving upwards and downwards along the guide hole. by containing the guide column inside the guide hole and positioning the guide hole from the center thereof, the guide core moves axially, which further avoids the guide core from tilting or being stuck while moving upwards and downwards, thus ensuring smooth operation.

### BRIEF DESCRIPTION OF THE DRAWINGS

FIG. 1 is an exploded view of the keyboard switch according to the present application;

FIG. 2 is an exploded view of the keyboard switch from another perspective according to the present application;

FIG. 3 is an exploded view of the keyboard switch from yet another perspective according to the present application;

FIG. 4 is a structural view of the balance mechanism according to the present application;

FIG. 5 is a partial assembly view of the balance mechanism according to the present application;

FIG. 6 is another partial assembly view of the balance mechanism according to the present application;

FIG. 7 illustrates a structural view of the cover of the present application;

FIG. 8 illustrates a structural view of the base body of the present application;

FIG. 9 illustrates a structural view of the guide core of the present application;

FIG. 10 illustrates a structural view of the static contact of the present application;

FIG. 11 illustrates a structural view of the dynamic contact of the present application;

FIG. 12 illustrates a structural view of the keyboard switch under free state of the present application; and

FIG. 13 illustrates a structural view of the keyboard switch under pressed state of the present application.

### DETAILED DESCRIPTION OF THE PREFERRED EMBODIMENT

Technical solutions in the embodiments of the present application will be described hereinafter with reference to the accompanying drawings.

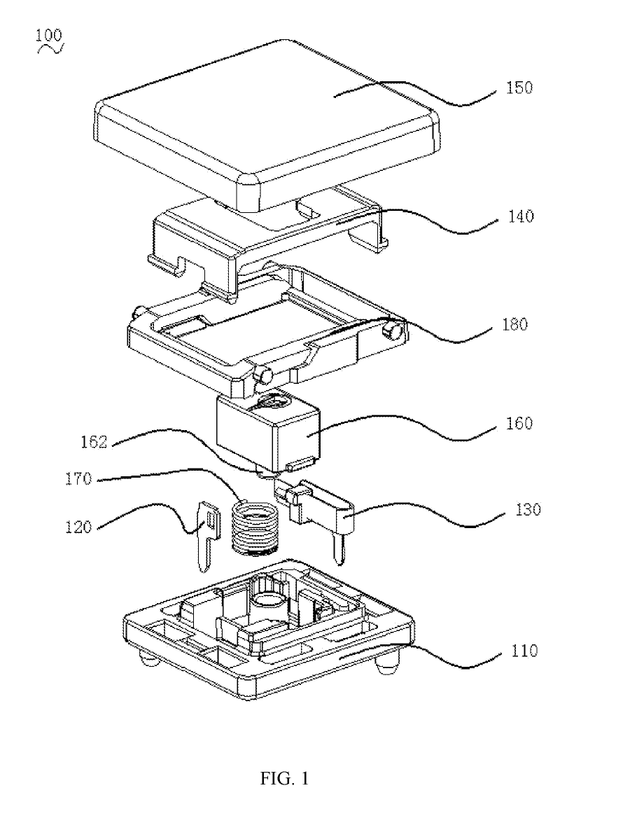

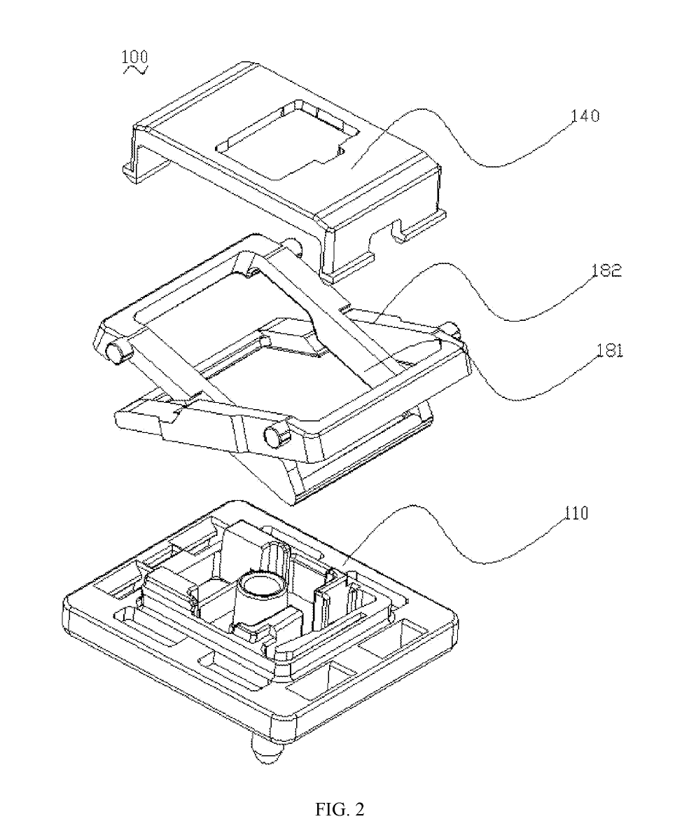

FIG. 1 through FIG. 3 are exploded views of the keyboard switch from different perspectives according to the present application. A keyboard switch 100 that includes a base body 110, a static contact 120, a dynamic contact 130, a cover 140, a keycap 150, a guide core 16 configured for moving the dynamic contact 130 so as to contact the static contact 120 with the dynamic contact 130, and a return spring 170 applying force on the guide core 160 which returns under the force is provided. The keyboard switch 100 further includes a balance mechanism 180 positioned between the cover 140 and the base body 110 and configured for guiding the keycap 150 to balanced downward push so as to avoid the guide core 160 from tilting.

Both ends of the guide core 160 pass through the balance mechanism 180; the cover 140 is buckled on the base body 110; the static contact 120 and the dynamic contact 130 are both arranged on the base body 110; one end of the guide core 160 is installed on and capable of moving upwards and downwards relative to the base body 11; the other end of the guide core 160 passes through the cover 140 and is under the keycap 150; both upper and lower ends of the return spring 170 are respectively abutted against the guide core 160 and the base body 110.

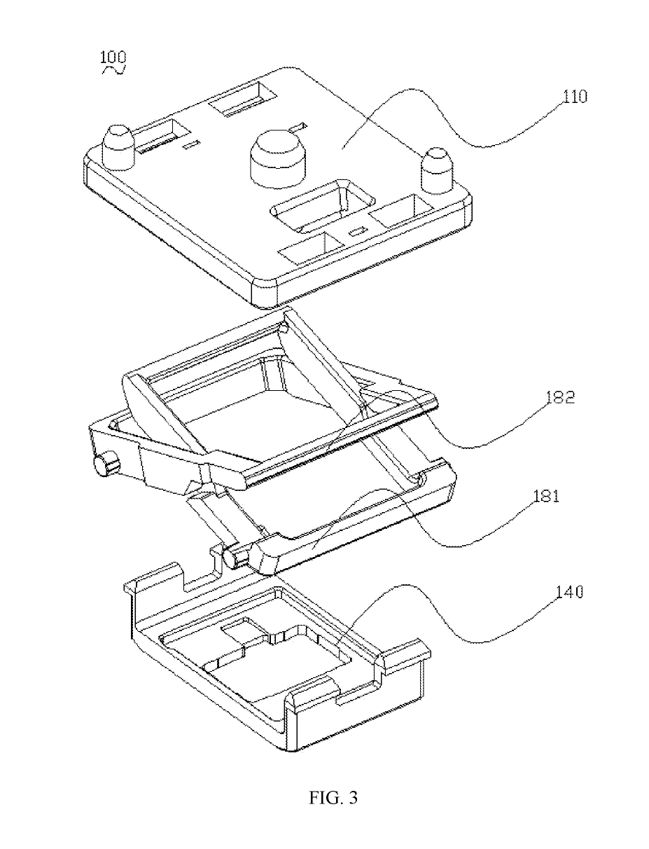

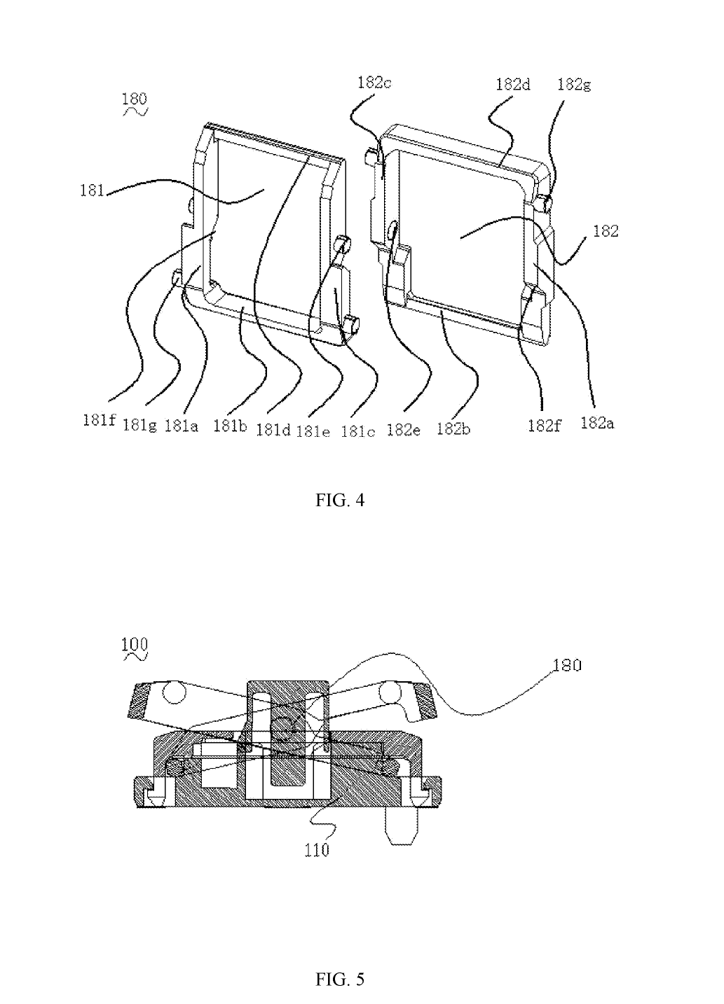

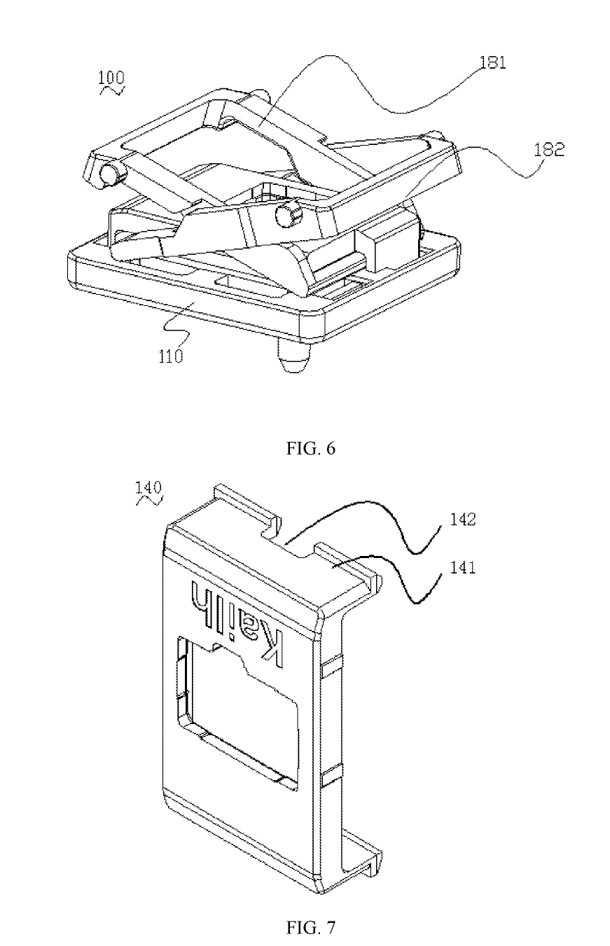

As shown in FIG. 4 through FIG. 6, a structural view and two partial assembly views of the balance mechanism according to the present application are respectively provided.

The balance mechanism 180 comprises a first frame 181 and a second frame 182 which are rotatable relative to each other for moving the dynamic contact 130; the first frame 181 and the second frame 182 are both of hollow structures with matched shapes and sizes. While the first frame 181 and the second frame 182 are superimposed, the dynamic contact 130 and the static contact 120 are electrically connected; while the dynamic contact 130 and the static contact 120 as a whole are of an “X” structure, then the dynamic contact 130 and the static contact 120 are detached.

Both the first frame 181 and the second frame 182 are quadrangular. The first frame 181 includes a first side 181a, a second side 181b, a third side 181c and a fourth side 181d connected sequentially, the first side 181a being parallel to the third side 181c, the second side 181b being parallel to the fourth side 181d. The second frame 182 includes a fifth side 182a, a sixth side 182b, a seventh side 182c and an eighth side 182d connected sequentially, the fifth side 182a being parallel to the seventh side 182c, the sixth side 182b being parallel to the eighth side 182d. First convex columns 181e are respectively arranged in the middle of the first side 181a and the third side 181c symmetrically; first holes 182e are respectively arranged in the middle of the fifth side 182a and the seventh 182c symmetrically. First inclined planes 181f are respectively arranged in the middle of the first side 181a and the third side 181c symmetrically; second inclined planes 182f are respectively arranged along the fifth side 182a and the seventh side 182c. The first inclined planes and the second inclined planes are superimposed with each other and the first convex columns 181e are rotatably mounted in the first holes 182e, such that the first frame 181 and the second frame 182 may rotate along the first inclined planes 181f and the second inclined planes 182f centered on the first holes 182e. Second convex columns 181g are respectively arranged at one end of each of the first side 181a and a third side 181c symmetrically; third convex columns 182g are respectively arranged at one end of each of the fifth side 182a and the seventh side 182c symmetrically away from the second convex columns 181g.

FIG. 7 illustrates a structural view of the cover of the present application. Each of two opposite sides of the bottom of the cover 140 provides two support tables 141; the second convex columns 181g and the third convex columns 182g are slidably installed on the support tables 141 which are spaced away from each other with a notch 142 therebetween. The guide core 160 provides a positioning component 161 corresponding to the notch 142, which positioning component 161 is stuck in the notch 142.

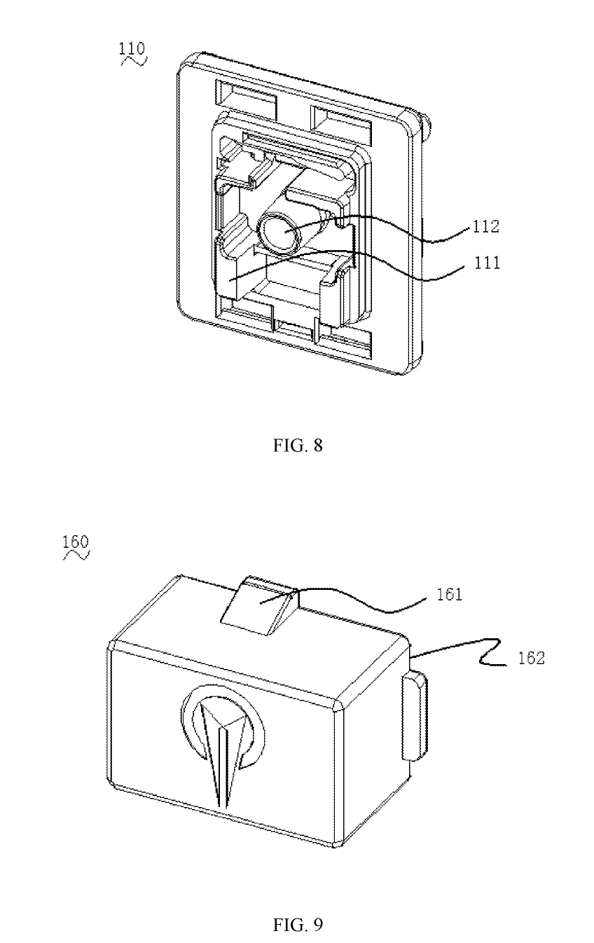

FIG. 8 illustrates a structural view of the base body of the present application. The base body 110 provides support bases 111 where four corners of the balance mechanism are corresponded. The first frame 181 and the second frame 182 may be stuck in the support bases 111.

FIG. 9 illustrates a structural view of the guide core of the present application. A side of the guide core 160 facing the base body 110 provides a guide column 162. Correspondingly, the base body 110 provides a guide hole 112. The guide column 162 may be mounted in the guide hole 112 and capable of moving upwards and downwards along the guide hole 112.

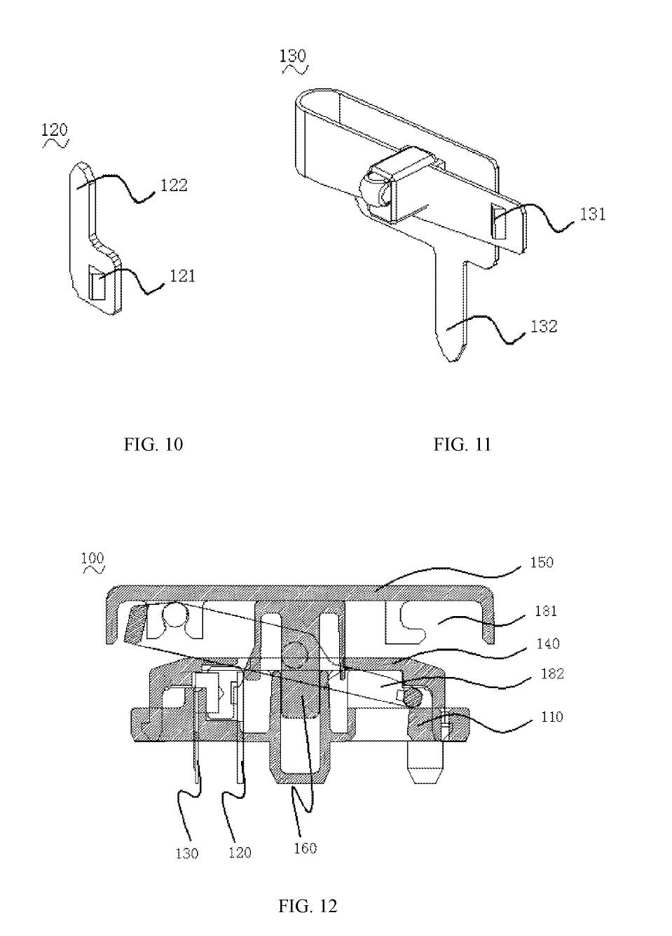

FIG. 10 and FIG. 11 illustrate structural views of the static contact and the dynamic contact of the present application respectively. The static contact 120 includes a static contact point 121 and a first welding leg 122; the dynamic contact 130 includes a dynamic contact point 131 and a second welding leg 132; the static contact point 121 and the dynamic contact point 1312 are arranged opposite to each other. Both the first welding leg 122 and the second welding leg 132 protrude beyond the base body 110.

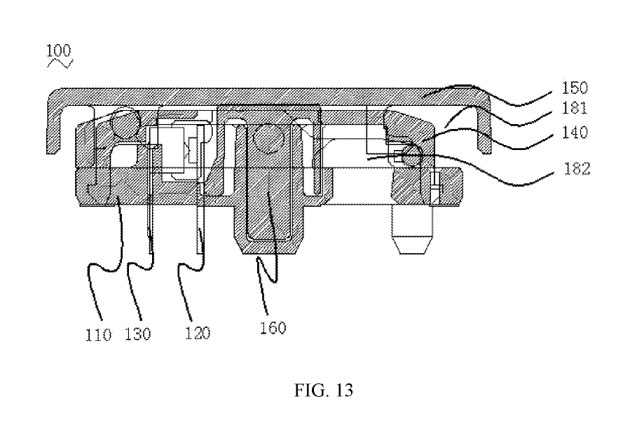

Principles for the present application are as follows. FIG. 12 and FIG. 13 illustrate structural views of the keyboard switch under free state and pressed state respectively of the present application. Assemble process is as follows: firstly, installing the static contact 120 and the dynamic contact 130 on the base body 110 such that the first welding leg 122 of the static contact 120 and the second welding leg 132 of the dynamic contact 130 both protrude downwards beyond the base body; secondly, abutting the return spring 170 beneath the guide column 162 of the guide core 160, wherein the guide column 162 may be contained within the guide hole 112 and capable of moving upwards and downwards; the return spring 170 is also contained within the guide hole 112; and the lower end of the return spring 170 is embedded into the base body 110; installing the balance mechanism 180 on the support base 111 of the base body; at last, covering the cover 140 and the keycap 150 on the balance mechanism 180. Under the free state, the first frame 181 and the second frame 182 as a whole are of an “X” structure; the first frame 181 and the second frame 182 support the keycap 150 via the second side 181b, the fourth side 181d, the sixth side 182b and the eighth side 182d; the guide core 160 abuts against the dynamic contact 130 such that the dynamic point 131 of the dynamic contact 130 and the static point 121 of the static contact 120 maintain a detached state and the switch 100 is in an off state. While a force works upon the keycap 150, the force is transmitted through the keycap 150 to the guide core 160 which then moves downwards, and the first frame 181 and the second frame 182 rotate, thus changing the angle therebetween constantly to move the dynamic contact 130, support the keycap 150 and keep the guide core 160 from tilting during the press process. When the angle between the first frame 181 and the second frame 182 is 0, the first frame 181 and the second frame 182 are superimposed with each other, such that the dynamic contact 130 and the static contact 120 are contacted and the switch is in an on-state.

The keyboard switch 100 of the present application further includes a balance mechanism 180 positioned between the cover 140 and the base body 110. The first frame 181 and the second frame 182 of the balance mechanism 180 rotate relative to each other so as to move the dynamic contact 130, thus detaching or connecting the dynamic contact 130 from or with the static contact 120 and turning on or off the switch 100. On one hand, the balance mechanism 180 works on the dynamic contact 130 such that the guide core 160 need not be too long, and each of the components is connected in a compact and simple way; furthermore, while the switch 100 is in the on-state, the first frame 181 and the second frame 182 are superimposed, such that the keyboard switch of the present application is thin and small in size, which helps miniaturize the switch 100; on the other hand, the cover 140 is arranged between the guide core 160 and the keycap 150, such that interior part of the balance mechanism 180 is capable of supporting two ends of the cover 140 while the keycap 150 is under pressure, such that two sides of the guide core 160 are under equal forces and the guide core 160 is not liable to tilting or being stuck, which achieves comfortable hand feeling with convenient operation.

The first frame 181 and the second frame 182 are rotatably mounted in the first hole 182e via the first convex column 181e, such that the first frame 181 and the second frame 182 may rotate along the first inclined planes 181f and the second inclined planes 182f centered on the first holes 182e so as to move the dynamic contact 130. Furthermore, the first frame 181 and the second frame 182 are slidably installed on the support tables 141 of the cover 140 via the second convex columns 181g and the third convex columns 182g, which makes the structure of the keyboard switch compact with high space utilization and thinness, thus facilitating product miniaturization.

A notch 142 is provided between the two support tables 141; the guide core 160 provides a positioning component 161 to which the notch 142 is corresponded, which positioning component 161 is stuck in the notch 142, thus further avoiding the guide core 160 from tilting or being stuck while moving upwards and downwards and ensuring smooth operation.

The guide core 160 provides a guide column 162; correspondingly, the base body 110 provides a guide hole 112. The guide column 162 may be mounted in the guide hole 112 and capable of moving upwards and downwards along the guide hole 112. By containing the guide column 162 inside the guide hole 112 and positioning the guide hole 112 from the center thereof, the guide core 160 moves axially, which further avoids the guide core 160 from tilting or being stuck while moving upwards and downwards, thus ensuring smooth operation.

The above-described embodiments merely represent several embodiments of the present invention, and the description thereof is more specific and detailed, but it cannot be understood as limiting the scope of the patent of the present invention. It should be noted that, for those skilled in the art, several variations and improvements may be made without departing from the concept of the present invention, and these all fall within the protection scope of the present invention. Therefore, the scope of protection of the present application shall be subject to the appended claims.

What is claimed is:

1. A balance mechanism, comprising a first frame and a second frame which are rotatable relative to each other; the first frame and the second frame are both of hollow structures with matched shapes and sizes; while the first frame and the second frame are superimposed, a dynamic contact and a static contact are electrically connected; while the dynamic contact and the static contact as a whole are of an “X” structure, the dynamic contact and the static contact are detached.

2. The balance mechanism of claim 1, wherein both the first frame and the second frame are quadrangular; the first frame includes a first side, a second side, a third side and a fourth side connected sequentially, the first side being parallel to the third side, the second side being parallel to the fourth side; the second frame includes a fifth side, a sixth side, a seventh side and an eighth side connected sequentially, the fifth side being parallel to the seventh side, the sixth side being parallel to the eighth side; first convex columns are respectively arranged in middle of the first side and the third side symmetrically; first holes are respectively arranged in middle of the fifth side and the seventh symmetrically; first inclined planes are respectively arranged in middle of the first side and the third side symmetrically; second inclined planes are respectively arranged along the fifth side and the seventh side; the first inclined planes and the second inclined planes are superimposed with each other and the first convex columns are rotatably mounted in the first holes, such that the first frame and the second frame may rotate along the first inclined planes and the second inclined planes centered on the first holes; second convex columns are respectively arranged at one end of each of the first side and a third side symmetrically; third convex columns are respectively arranged at one end of each of the fifth side and the seventh side symmetrically away from the second convex columns.

3. A keyboard switch including the balance mechanism of claim 1, comprising a base body, a static contact, a dynamic contact, a cover, a keycap, a guide core configured for moving the dynamic contact so as to contact the static contact with the dynamic contact, and a return spring applying force on the guide core which returns under the force; the cover is buckled on the base body; the static contact and the dynamic contact are both arranged on the base body; one end of the guide core is installed on and capable of moving upwards and downwards relative to the base body; the other end of the guide core passes through the cover and is under the keycap; both upper and lower ends of the return spring are respectively abutted against the guide core and the base body; the keyboard switch further includes a balance mechanism positioned between the cover and the base body and configured for guiding the keycap to balanced downward push so as to avoid the guide core from tilting.

4. A keyboard switch including the balance mechanism of claim 2, comprising a base body, a static contact, a dynamic contact, a cover, a keycap, a guide core configured for moving the dynamic contact so as to contact the static contact with the dynamic contact, and a return spring applying force on the guide core which returns under the force; the cover is buckled on the base body; the static contact and the dynamic contact are both arranged on the base body; one end of the guide core is installed on and capable of moving upwards and downwards relative to the base body; the other end of the guide core passes through the cover and is under the keycap; both upper and lower ends of the return spring are respectively abutted against the guide core and the base body; the keyboard switch further includes a balance mechanism positioned between the cover and the base body and configured for guiding the keycap to balanced downward push so as to avoid the guide core from tilting.

5. The keyboard switch of claim 3, wherein each of two opposite sides of bottom of the cover provides two support tables; the second convex columns and the third convex columns are slidably installed on the support tables.

6. The keyboard switch of claim 4, wherein each of two opposite sides of bottom of the cover provides two support tables; the second convex columns and the third convex columns are slidably installed on the support tables.

7. The keyboard switch of claim 5, wherein the two support tables are spaced away from each other with a notch formed between the two support tables; the guide core provides a positioning component corresponding to the notch, which positioning component is stuck in the notch.

8. The keyboard switch of claim 6, wherein the two support tables are spaced away from each other with a notch formed between the two support tables; the guide core provides a positioning component corresponding to the notch, which positioning component is stuck in the notch.

9. The keyboard switch of claim 7, wherein the base body provides support bases where four corners of the balance mechanism are corresponded; the first frame and the second frame are stuck in the support bases.

10. The keyboard switch of claim 8, wherein the base body provides support bases where four corners of the balance mechanism are corresponded; the first frame and the second frame are stuck in the support bases.

11. The keyboard switch of claim 9, wherein a side of the guide core facing the base body provides a guide column; correspondingly, the base body provides a guide hole; the guide column is mounted in the guide hole and capable of moving upwards and downwards along the guide hole.

12. The keyboard switch of claim 10, wherein a side of the guide core facing the base body provides a guide column; correspondingly, the base body provides a guide hole; the guide column is mounted in the guide hole and capable of moving upwards and downwards along the guide hole.

13. The keyboard switch of claim 11, wherein the static contact includes a static contact point and a first welding leg; the dynamic contact includes a dynamic contact point and a second welding leg; the static contact point and the dynamic contact point are arranged opposite to each other; both the first welding leg and the second welding leg protrude beyond the base body.

14. The keyboard switch of claim 12, wherein the static contact includes a static contact point and a first welding leg; the dynamic contact includes a dynamic contact point and a second welding leg; the static contact point and the dynamic contact point are arranged opposite to each other; both the first welding leg and the second welding leg protrude beyond the base body.
